(19) United States
(12) Patent Application Publication
(10) Pub. No.: US 2026/0307845 A1
(43) Pub. Date: Oct. 8, 2026

(54) EXTRUSION BLOW MOLDED CONTAINER AND METHOD

(71) Applicant: Plastipak Packaging, Inc., Plymouth, MI (US)

(72) Inventors: Zachary T. Liebrecht, Fort Jennings, OH (US); James C. Dorn, Sterling, OH (US); Gary Michael Ferguson, Tallmadge, OH (US); Jimmie Faddis, Lima, OH (US); Lisa Zimpfer, Jackson Center, OH (US)

(21) Appl. No.: 19/638,290

(22) Filed: Apr. 3, 2026

Related U.S. Application Data
(60) Provisional application No. 63/782,947, filed on Apr. 3, 2025.

(51) Int. Cl. B65D 1/02; B29C 49/04; B29C 49/22; B29K 105/26; B29L 31/00; B65D 1/40

(52) U.S. Cl. CPC B65D 1/0215; B29C 49/04112; B29C 49/22; B65D 1/0223; B65D 1/40; B29K 2105/26; B29L 2031/7172

(57) ABSTRACT

An extrusion blow molded plastic container includes a first opening; a second opening; a handle portion disposed between the first opening and the second opening; and a base portion. The base portion may include an outer base portion, including a support surface, and an inner base portion with a pushup portion. In an embodiment, the plastic container has a capacity of at least 150 fluid ounces, an unlabeled and unfilled weight of 172 grams or less, a wall thickness at a sidewall portion within a label panel area of 0.032 inches or less, and a wall thickness at a central portion of a pushup portion of a base of 0.024 inches or less; and may include a notch in a heel portion of the base portion. Embodiments of such plastic containers can pass a 45 pound top load strength test and a static four foot drop test.

### CROSS-REFERENCE TO RELATED APPLICATION

This application claims the benefit under 35 U.S.C. §119(e) of U.S. Provisional Patent Application No. 63/782,947, filed on Apr. 3, 2025, the disclosure of which is incorporated herein by reference in its entirety.

### TECHNICAL FIELD

The present invention relates to extrusion blow molded containers, including extrusion blow molded containers that may be lightweighted, and methods for making or using such containers.

### BACKGROUND

Plastic containers, including those storing liquid contents, are widely employed in the industry. Such containers may include one or more openings for dispensing contents. Such containers, particularly larger volume containers filled with product contents, can present a number of challenges including managing top load strength, or top loads. Top load strength may refer to the ability of a container to withstand vertical forces, such as those associated with stacked loads, whether for transport or storage, and/or whether such containers are unfilled or in final form filled with product. Top loading may involve, among other things, a balancing of several factors such as container structural features and strength, material composition, material efficiency and distribution, and manufacturability.

Moreover, some commercial products may become associated with particular plastic container configurations. In some instances, commercial product suppliers want to package their products in containers that have a substantially similar overall appearance to that which consumers may be familiar and that can maintain functional operability, but yet can be made at reduced cost, e.g., made of less material. However, merely lightweighting a container by simply forming the container with thinner walls can result in a container that cannot maintain required or desired top loading functionality and/or that may be vulnerable to deformation or crushing when stacked.

Among other things, it can be desirable to provide an extrusion blow molded container that is comparatively lightweight, may be structurally fairly similar in overall configuration, and can still maintain structural integrity with a sufficient top load for intended applications.

### SUMMARY

An embodiment of an extrusion blow molded plastic container includes a first opening; a second opening disposed on an opposite side of the plastic container from the first opening; a handle portion disposed between the first opening and the second opening; a sidewall portion including a first label panel on a first side of the plastic container and a second label panel on an opposite second side of the plastic container; and a base portion comprising an outer base portion including a support surface and an inner base portion including a pushup portion. In some embodiments, the plastic container has a capacity of 150 fluid ounces or greater (e.g., about 154 fluid ounces) and an unlabeled and unfilled weight of less than 172 grams or 163±9 grams. Some embodiments may have a maximum height at a top of the second opening of about 276.10 mm, a maximum height of the pushup portion above a lowermost portion of the plastic container of about 0.79 mm, and/or a softened notch in a heel portion of the base portion. In an embodiment, a wall thickness of the plastic container at a sidewall portion within a label panel area is 0.032 inches or less, and a wall thickness at a central portion of the pushup portion is 0.024 inches or less. Such a plastic container may be capable of passing a 45-pound top load strength test and a four-foot free-fall drop test.

An embodiment of a multi-layer extrusion blow molded plastic container includes an inner polymer layer; a middle polymer layer disposed between the inner polymer layer and an outer polymer layer, the middle polymer layer comprising up to 50% post-consumer recycled (PCR) content; the inner polymer layer comprising virgin polymer material with little or no added colorant; and at least one adhesive layer disposed between adjacent polymer layers. In an embodiment, the inner, middle, and outer polymer layers respectively comprise about 10%, about 65%, and about 25% of the total weight of the container (unlabeled and unfilled). In some embodiments, the inner layer comprises 15% or less, or even 10% or less, or about 10% of the total weight of such container; the middle layer comprises at least 50% up to 90%, at least 60%, at least 65%, or about 65% of the total weight of such container; and the outer layer comprises 35% or less, 25% or less, or about 25% of the total weight of such container. In an embodiment, such a multi-layer container has a capacity of at least 150 fluid ounces (e.g., about 154 fluid ounces), a wall thickness at a sidewall portion within a label panel area of 0.032 inches or less, and a wall thickness at a central portion of a pushup portion of the base of 0.024 inches or less.

An embodiment of a method of forming a lightweight extrusion blow molded plastic container with controlled material distribution includes extruding a multi-layer parison comprising at least an outer layer, a middle layer, and an inner layer with at least one adhesive layer disposed between adjacent layers, wherein parison wall thickness is controlled such that a wall thickness of the formed container at a sidewall portion within a label panel area is 0.032 inches or less and a wall thickness at a central portion of a pushup portion of a base of the formed container is 0.024 inches or less; inflating the parison within a blow mold using compressed air to form the plastic container such that the inner layer comprises virgin polymer material with little or no added colorant, the middle layer comprises up to 50% post-consumer recycled content, and the inner, middle, and outer layers respectively comprise 10% or less, at least 50%, and 30% or less of a total weight of the formed container (unlabeled and unfilled); and cooling the formed container to solidify the layers, wherein, in some embodiments, the formed container has a capacity of at least 150 fluid ounces (e.g., about 154 fluid ounces) and an unlabeled and unfilled weight of less than 172 grams for some implementations or 163±9 grams with other implementations.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a right side view of an embodiment of a plastic container, with closures, according to aspects or teachings of the present disclosure;

FIG. 2 is a left side view of the plastic container shown in FIG. 1;

FIG. 3 is top plan view of the plastic container shown in FIG. 1;

FIG. 4 is a bottom plan view of the plastic container shown in FIG. 1;

FIG. 5 is a rear view of the plastic container shown in FIG. 1;

FIG. 6 is a front view of the plastic container shown in FIG. 1;

FIG. 7 is a top-rear-left side perspective view of the plastic container shown in FIG. 1;

FIG. 8 is a top-front-right side perspective view of the plastic container shown in FIG. 1;

FIG. 9 is a top-right side-front perspective view of a plastic container according to aspects or teachings of the present disclosure, excluding a dispenser and closures;

FIG. 10 is a right side view of the plastic container shown in FIG. 9;

FIG. 11 is a top-left-rear perspective view of a plastic container according to aspects or teachings of the present disclosure, excluding a dispenser and closures;

FIG. 12 is a left side view of the plastic container shown in FIG. 11;

FIG. 13 is a partial top plan view of the plastic container shown in FIG. 11;

FIG. 14 is a front view of the plastic container shown in FIG. 11;

FIG. 15 is a rear view of the plastic container shown in FIG. 11;

FIG. 16 is a partial bottom plan view of the plastic container shown in FIG. 11;

FIG. 17 is a detail A from FIG. 14;

FIG. 18 is a right side view of the plastic container shown in FIG. 11;

FIG. 19 is a comparative view of left side views of a conventional plastic container and an embodiment of a plastic container according to aspects or teachings of the present disclosure;

FIG. 20 is a comparative view of left side views of a conventional plastic container and an embodiment of a plastic container according to aspects or teachings of the present disclosure;

FIG. 21 is a comparative view of bottom views of a conventional plastic container and an embodiment of a plastic container according to aspects or teachings of the present disclosure;

FIG. 22 is a comparative view of left side views of a conventional plastic container and an embodiment of a plastic container according to aspects or teachings of the present disclosure;

FIG. 23 is a left side view of a plastic container including map points;

FIG. 24 is a front view of a plastic container including map points;

FIG. 25 is a rear view of a plastic container including map points;

FIG. 26 is a bottom plan view of a plastic container including map points; and

FIG. 27 is a table including thicknesses and comparative percentage changes with respect to different wall map points or profiles associated with FIGS. 23-26.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined herein and by appended claims.

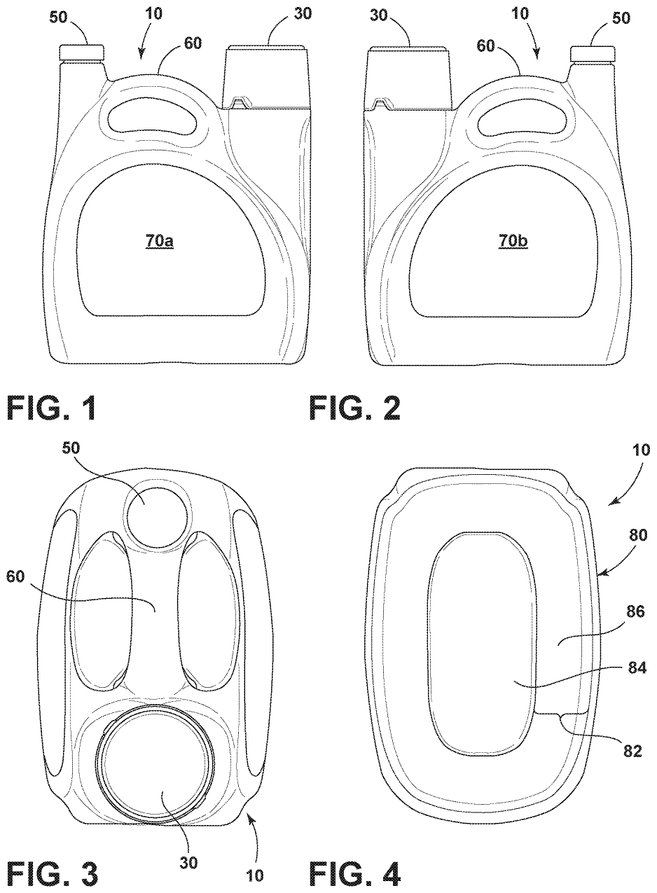

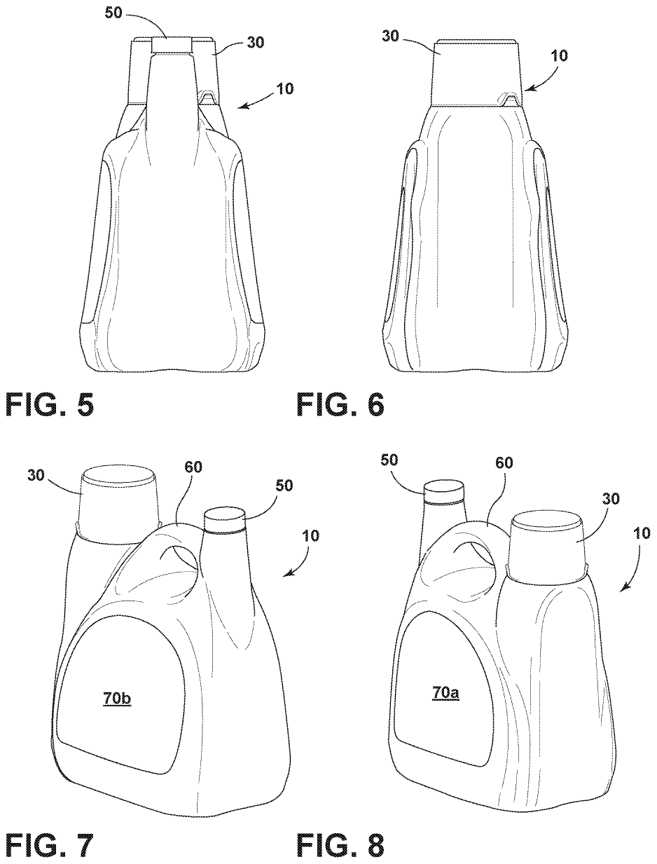

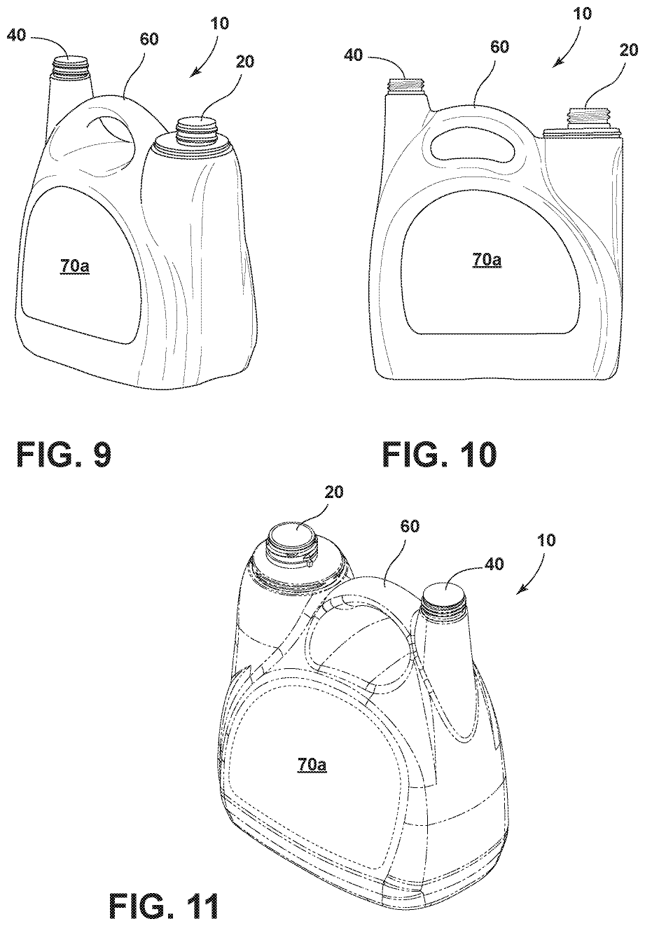

An embodiment of a plastic container 10, with closures included, is generally illustrated in several views in FIGS. 1-8. An embodiment of a plastic container, without closures, is generally illustrated in FIGS. 9 and 10. While not limited to a specific size/volume, an embodiment of a plastic container 10 may, such as generally illustrated in FIGS. 9 and 10, may have a first opening 20, which may have an overcap 30; an additional opening 40, which may have a closure 50; and a handle portion 60 disposed between the first opening 20 and the additional opening 40. The plastic container may be sized and configured to hold various storage capacities, including larger fluid capacities. Such content capacities may be, without limitation, greater than 130 fluid ounces, such as for example, 154 ounces. Some embodiments may be more than 160 ounces, 170 ounces, or even more.

As disclosed herein, with the changing of certain structural geometry associated with a given plastic container, such plastic container may be significantly lightweighted with respect to a current commercial design (or a materially similar size, shape, and configuration thereof), and may maintain sufficient top loading strength and, in some cases, may even provide increased top loading strength.

The plastic container 10 may be comprised of one or more different plastic materials, may include recycled plastic material content, and may be in the form of a multi-layer container. For example and without limitation, the plastic container 10 may be comprised of high density polyethylene (HDPE), polypropylene (PP), and/or polyethylene terephthalate (PET). Such containers may also be comprised of post consumer recycled (PCR) content.

Embodiments of plastic containers 10 as disclosed may comprise single or multi-layer containers. An embodiment of a plastic container 10 with a multi-layer configuration may, for example and without limitation, comprise at least three layers-an outer layer, an inner layer, and a middle layer disposed between the inner layer and the outer layer and comprised of up to 50% PCR. Some embodiments may have five layers, which may comprise three polymer layers with two adhesive layers, with an adhesive layer provided between and separating the three polymer layers. The adhesive layer may, for example and without limitation, comprise a maleic anhydride-functionalized polyolefin or other compatible tie-layer resin that maintains structural integrity between polymer layers. With some embodiments, the plastic container (unlabeled and unfilled) may have: (i) a thin inner layer (which may be devoid of colorant) that may comprise less than 10% of the total bottle weight; (ii) a substantial middle layer that may comprise about 65% or more of the total bottle weight (and may include reground material and/or PCR, and which may include some virgin material and/or some colorant(e.g., up to about 6% of the layer or up to 1.5% of the total bottle weight)); and (iii) an outer layer that may comprise 25% or less of the total weight. In some embodiments, the inner layer comprises 15% or less, or even 10% or less, or about 10% of the total weight of such container; the middle layer comprises at least 50% up to 90%, at least 60%, at least 65%, or about 65% of the total weight of such container; and the outer layer comprises 35% or less, 25% or less, or about 25% of the total weight of such container. The inner layer may comprise virgin material and/or little or no colorant, such as no added pigment or dye or other colorant composition. In implementations, the total bottle may have about 2.3% or less colorant, by weight-with an outer layer having the majority of the colorant, a middle layer having some colorant (but less than the outer layer), and an inner layer essentially having no colorant.

In embodiments, a hollow plastic container 10 is formed by extrusion blow molding (EBM). The formation process may involve the extrusion of melted plastic resin into a hollow tube or parison. A blow mold may enclose the parison, and compressed air can be introduced to inflate the parison such that the parison conforms to the shape of the blow mold. A period of cooling may be involved, after which the blow mold may open, and a finished part, i.e., plastic container, may be removed or ejected. With some embodiments, such as those associated with high-volume production, a wheel system or apparatus may be used. With a wheel system or apparatus, multiple blow molds may be mounted on a rotating wheel that may continuously cycle through extrusion, molding, and removal/ejection stages.

Assemblies associated with such plastic containers may include an overcap 30 and/or closure 50, which may also be comprised of plastic, including those noted above. Embodiments of an overcap 30 may, for example and without limitation, be clear (see-through) or opaque. Further, an overcap 30 may comprise a dosing cup and/or may include various markings, including measurement values or other information. Such markings may be formed as part of the overcap 30.

As generally shown, for example in FIGS. 1 and 2, a plastic container may include one or more label panels-such as for example and without limitation-a first label panel 70a (on a first/right side) and a second label panel 70b (on a second/left side). Further, as generally shown in FIG. 4, a plastic container 10 may include a base portion 80 that may comprise an outer base portion 82 and an inner base portion 84. The outer base portion 82 may include a support surface 86 that may be configured to support the plastic container 10 on an external surface. With embodiments, the base portion 80 is configured to permit the plastic container 10 to be freestanding or self-supporting in an upright position on generally horizontal support surfaces.

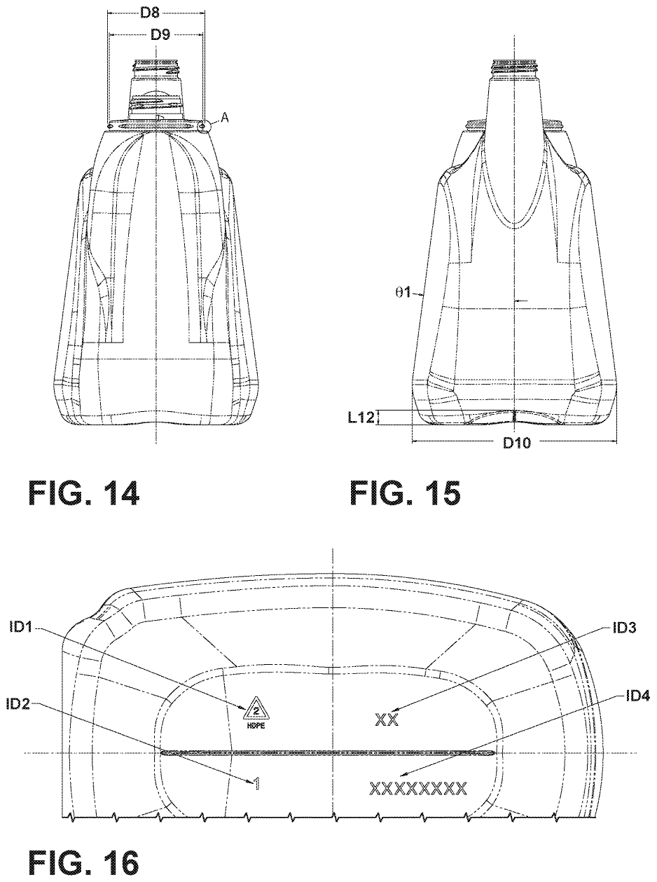

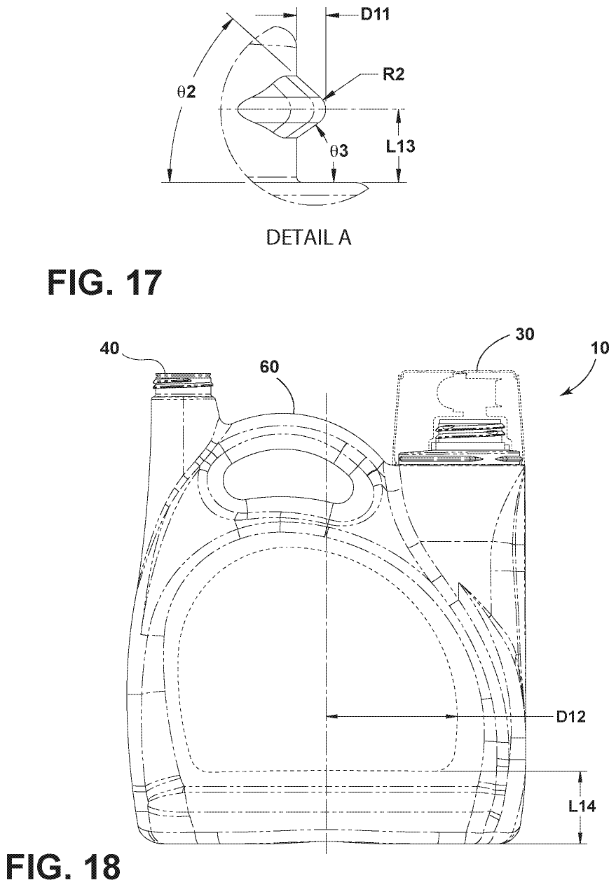

FIGS. 11-18 illustrate different views and portions of an embodiment of a plastic container 10 embodying aspects or teachings associated with the present disclosure, and including certain exemplary dimensions. The illustrated plastic container is formed from HDPE, has a capacity of 154 fluid ounces, and has a weight of 163±9 grams (unlabeled and unfilled) and 166±9 grams (labeled and unfilled). With other embodiments, the weight may be 172 grams or less. The illustrated container 10 can adequately meet (pass) associated top load testing (e.g., 45 pounds of top load force and/or torsional top load force resistance in the 16-25 lb-force range) and/or static drop testing (e.g., four foot static drop test). That is contrasted with conventional commercial versions of a plastic container having an overall size, shape, and configuration substantially as shown but with an unfilled weight (excluding contents and other attachments/items) of about 184 or 185 grams in order to adequately meet (pass) such top load and static drop testing (e.g., 45 pounds of top load force and/or torsional top load force resistance in the 16-25 lb-force range; 4 foot static drop test). Moreover, some versions of the presently disclosed plastic containers may pass such top load testing and static drop testing with unfilled (and unlabeled) weights of 151 grams, 139 grams, or even less than 139 grams. As such, embodiments of a plastic container as disclosed herein may be provided with a weight, for example, of about 169 grams and provide sufficient functionality (including top load strength and drop test stability) of a similarly shaped/configured container having a weight of about 184 grams-providing a weight savings of 8% or more. Embodiments may provide, for example and without limitation, successful top load testing (e.g., 45 lbs) with weight savings/reductions of 8%, 10%, 18%, 25%, or even more than 25%. With embodiments of a 154 fluid ounce container, total weight savings may be about 8% to about 25%, or about 17% to about 25% with respect to similarly configured conventional 154 fluid ounce containers.

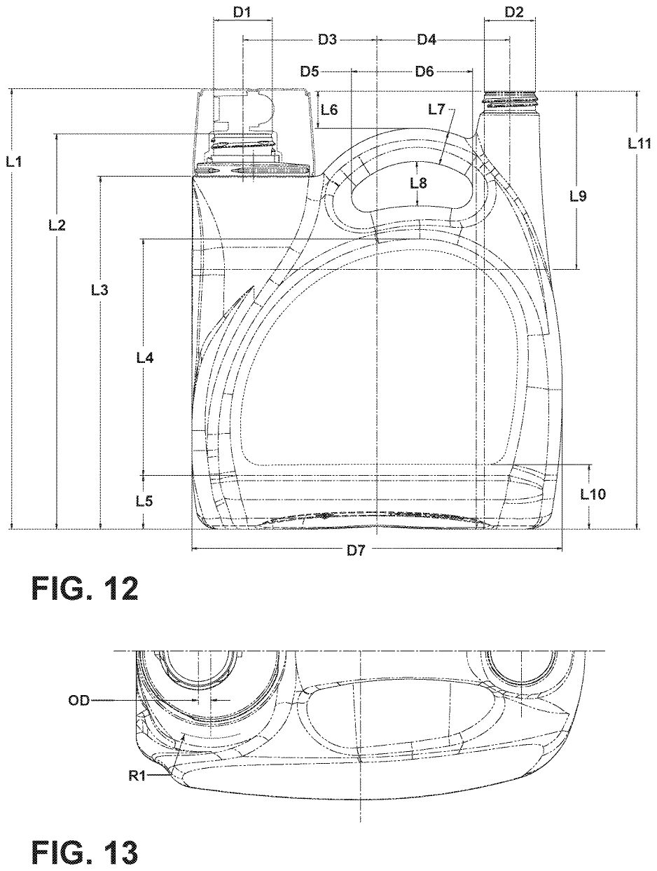

FIGS. 12-18 depict one illustrative embodiment of container 10 having example dimensions and dimensional relationships. For example, the illustrated embodiment may include dimensions of L1=10.930 in (277.62 mm), L2=9.805 in (249.05 mm), L3=8.755 in (222.38 mm), L4=5.873 in (149.18 mm), L5=1.331 in (33.80 mm), L6=0.922 in (23.42 mm), L7=0.825 in (20.96 mm), L8=1.100 in (27.94 mm), L9=4.430 in (112.52 mm), L10=1.602 in (40.68 mm), L11=10.870 in (276.10 mm), L12=0.425 in (10.79 mm), L13=0.139 in (3.53 mm), L14=1.680 in (42.68 mm), D3=3.325 in (84.46 mm), D4=3.300 in (83.82 mm), D6=3.009 in (76.43 mm), D7=9.200 in (233.68 mm), D8=2.902 in (73.71 mm), D9=2.792 in (70.92 mm), D10=6.100 in (154.94 mm), D11=0.055 in (1.40 mm), D12=3.022 in (76.77 mm), OD=0.254 in (6.45 mm), R1=1.845 in (46.86 mm), R2=0.031 in (0.79 mm), θ1=7.5°, θ2=42°, and θ3=35°. Diameters D1 and D2 may, for example, be dimensions associated with a press-tap and SP100 finish, respectively. Such values are exemplary only and are presented in connection with the depicted embodiment to illustrate certain possible sizes, contours, and relationships among features.

In some embodiments, and with reference to FIG. 16 and FIG. 26, the container may include one or more molded identification indicia disposed on a bottom or base region of the container. For example, the indicia may include a resin identification code (e.g., ID1), a mold and/or cavity identifier (e.g., ID2), manufacturer or source-identifying letters, symbols, or codes (e.g., ID3), and a drawing, tooling, part, and/or revision identifier (e.g., ID4). As shown, such indicia may be positioned within recessed and/or bounded regions of the base structure so as to permit traceability, manufacturing control, material identification, and product-source identification. The particular content, arrangement, number, and location of such indicia are illustrative only and may be varied, substituted, omitted, or combined in other embodiments unless expressly required by the claims.

As used in this disclosure, terms such as about and approximately are intended to reflect that exact numerical identity is not necessarily required and that minor variation may occur, for example, due to manufacturing tolerances, tooling variation, material selection, molding or blow-molding conditions, trimming, shrinkage, measurement technique, use conditions, or design choice. Accordingly, unless expressly stated otherwise or specifically required by the claims, the disclosed numerical values, angular relationships, radii, offsets, and other dimensions should not be understood as critical, mandatory, or limiting, and any one or more such values may vary independently or in combination while remaining within the scope of the present disclosure.

Top load strength testing may be conducted in accordance with ASTM D2659-16 (2023), Standard Test Method for Column Crush Properties of Blown Thermoplastic Containers, on unfilled containers conditioned at 23° C.±2° C. and 50%±5% relative humidity for not less than 40 hours. The test may be conducted at a deflection rate of one inch per minute (2.54 mm/min) to a deflection of 0.25 inches. A container “passes” the 45-pound top load strength test when it sustains a minimum axial compressive load of 45 pounds (200 N). ASTM D2659-16(2023) is incorporated herein by reference in its entirety.

The static four-foot drop test may, for example, follow ASTM D5276. “Static” is used to mean the container is at rest prior to release (as opposed to a dynamic conveyor simulation). Drop testing may be conducted in accordance with ASTM D5276-19, Standard Test Method for Drop Test of Loaded Containers by Free Fall, which is incorporated herein by reference in its entirety. A “four-foot static drop test” as used herein means a free-fall drop from a height of four feet (1.22 m) with the container in an unfilled condition, oriented flat-face down, onto a rigid impact surface. A container “passes” the drop test if it sustains no fracture, no leakage, and no closure separation upon impact.

Embodiments of plastic containers 10 formed in accordance with aspects or teachings of the present disclosure may, for example and among other things, provide weight reduction (such as those weights and/or percentages noted above) and still meet functional—e.g., top loading and static drop testing requirements. Such plastic containers may involve extruding parisons that are comparatively thinner (e.g., from a wall thickness perspective) and lightweighted with respect to similar sized conventional plastic containers having a substantially similar size, shape, and configuration.

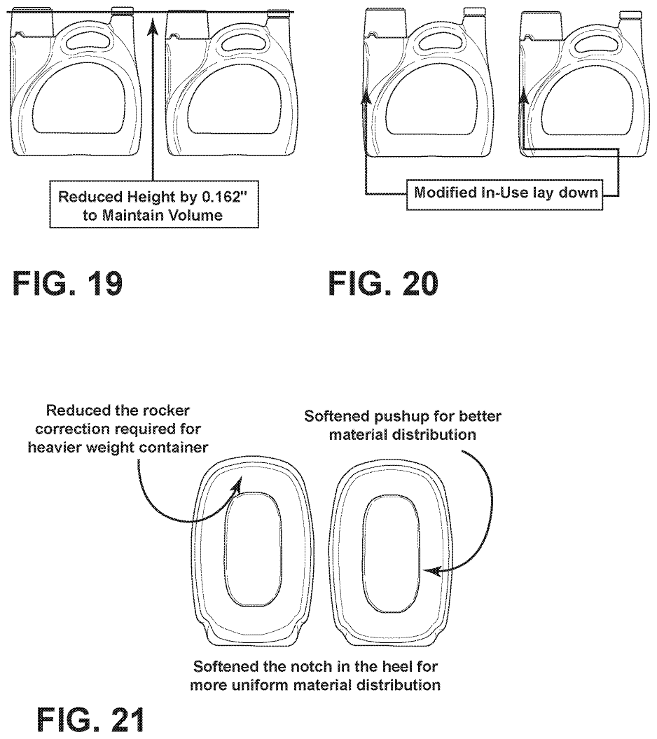

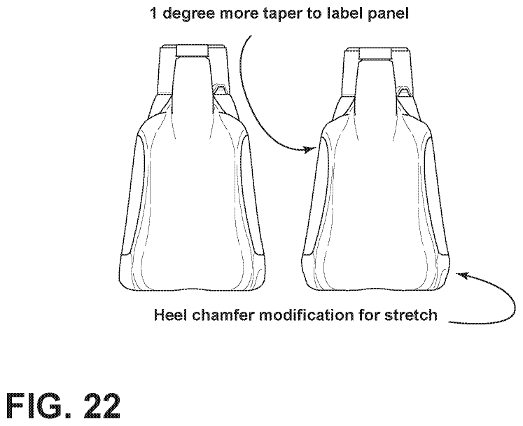

FIGS. 19 to 22 generally illustrate geometric/structural changes that may be made alone, or in various combinations, in connection with plastic containers in accordance with aspects or teachings of the present disclosure in contrast with similar conventional plastic containers. With respect to FIGS. 19, 20, and 22, conventional plastic containers are generally depicted on the left and plastic containers with teachings in accordance with this disclosure are generally shown on the right.

As generally disclosed in FIG. 19, an embodiment of an inventive plastic container (shown on the right) may have a reduced height (compared to conventional plastic containers, shown on the left), for example, of about 0.162 inches while maintaining the same container content volume.

As generally disclosed in FIG. 20, an embodiment of an inventive plastic container (shown on the right) may have a modified in-use lay down feature (compared to conventional plastic containers, shown on the left).

As generally disclosed in FIG. 21, an embodiment of a base portion of an inventive plastic container as disclosed herein (shown in both drawings) may include one or more modifications. Such modifications may involve, inter alia, (i) reduction of a rocker correction associated with heavier weight containers; (ii) softening of a pushup portion of the container for improved material distribution; and (iii) softening of a notch in the heel for more uniform material distribution. In some embodiments, such softened geometry may be achieved through one or more changes in curvature, contour, chamfer, depth, transition profile, or combinations thereof. As used herein, a “softened notch” or “softened pushup” refers to a geometry, relative to conventional geometry, having a more radiused contour, a smoother transition, a reduced depth discontinuity, a reduced sharpness, or combinations thereof.

As generally disclosed in FIG. 20, an embodiment of an inventive plastic container (shown on the right) may have a modified in-use lay-down feature, e.g., may have a tapered label panel that may, for example, have an additional 1 degree taper and/or include a heel chamfer (e.g., for stretch) as compared with a conventional plastic container (shown on the left). A chamfer modification to the heel, such as shown and disclosed, may, inter alia, improve stress crack resistance and/or dent resistance.

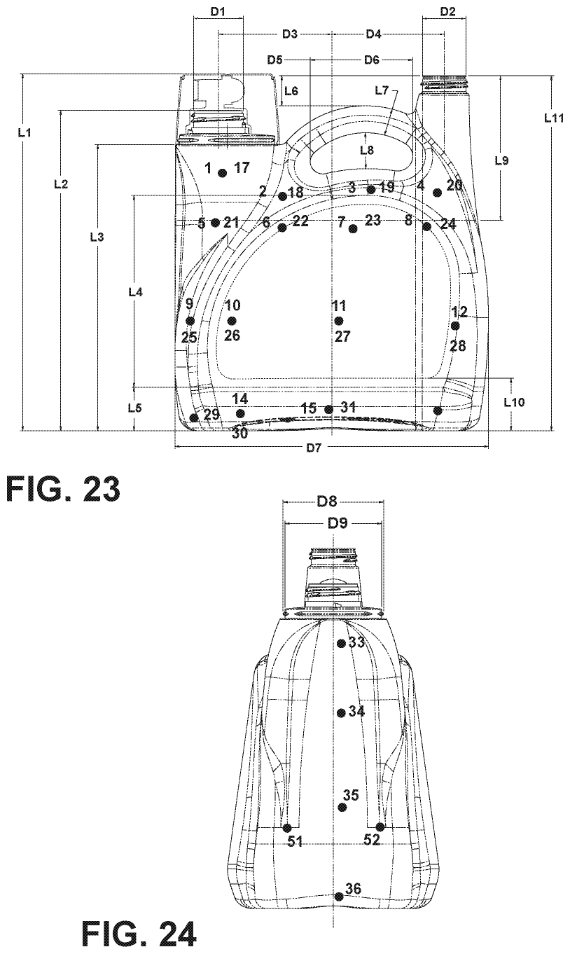

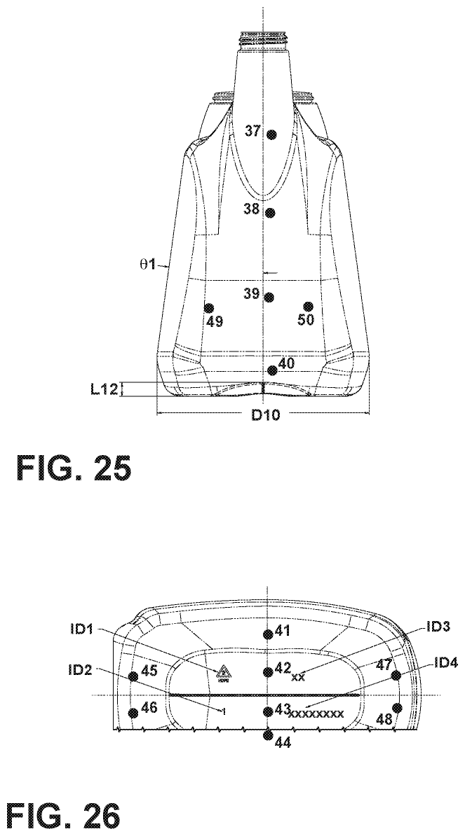

Plastic containers in accordance with aspects and teachings of the present disclosure exhibit wall thicknesses that are comparatively thinner than conventional plastic containers. FIGS. 23-26 illustrate a further non-limiting implementation of container 10 and associated example dimensional relationships with wall-map locations. By way of example, and without limitation, the illustrated implementation may include dimensions of D3=3.325 in (84.46 mm), D4=3.300 in (83.82 mm), L6=0.922 in (23.42 mm), D6=3.056 in (77.61 mm), L7=0.825 in (20.96 mm), L8=1.200 in (30.48 mm), L1=11.144 in (283.06 mm), L2=10.019 in (254.48 mm), and L3=8.969 in (227.81 mm), L4=6.267 in (159.18 mm), L5=0.952 in (24.18 mm), L9=4.537 in (115.24 mm), L11=11.084 in (281.53 mm), a sidewall offset dimension of 0.257 in (6.54 mm), D7=9.200 in (233.68 mm), D8=2.902 in (73.71 mm), D9=2.792 in (70.92 mm), and D10=6.100 in (154.94 mm). FIGS. 23-26 further identify wall-map locations 1-52 distributed across the container body. The foregoing values and point locations are illustrative dimensions associated with one depicted implementation and are not intended to define, require, or limit the claimed invention unless expressly recited in the claims, and any one or more such values, relationships, and locations may be varied, scaled, relocated, omitted, or otherwise modified in other embodiments.

Plastic containers provided in accordance with aspects or teachings of the present disclosure may be lighter in weight and have thinner wall sections in a significant number of portions/positions when compared to a conventional plastic container having a substantially similar size, shape, and configuration.

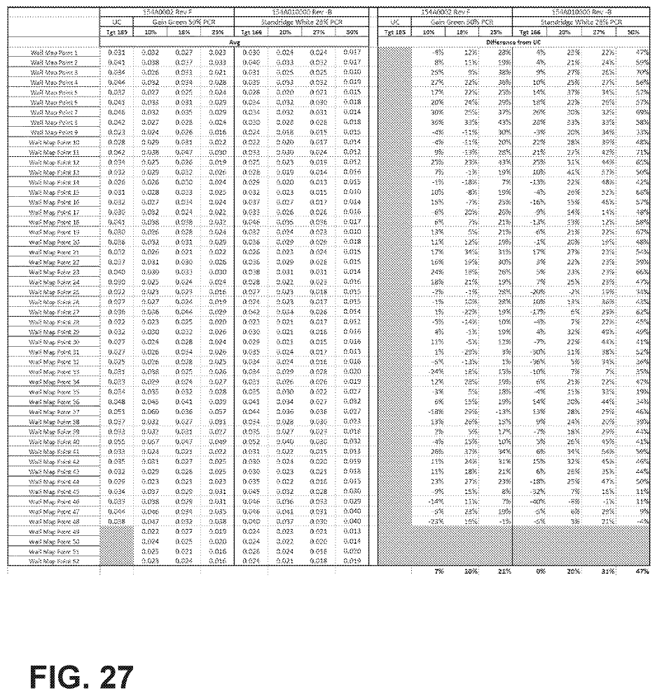

FIG. 27 is a table including thickness (in inches) and comparative percentage changes with respect to a number of wall map points positioned about a representative plastic container. The table includes different wall map points (in the form of rows)—i.e., Wall Map Point 1 through Wall Map Point 52. The designated Wall Map Points in the table are associated with the container positions as generally indicated in the representative container shown in FIGS. 23-26. The data associated with a current conventional plastic container is presented in the first column of the table—i.e., under the UC and “Tgt 185” designation (as having a weight of 185 grams). The “Rev F” version of the container in the tables is representative of such plastic container but with several different weight reductions, by percentages, e.g., 10%, 18%, 25%. In contrast, the “Rev B” represents a plastic container generally having the same configuration as the Rev F version but with additional structural changes as disclosed previously and exhibited in the prior drawings. The Tgt 166 column is indicative of a non-lightweight version of the plastic container. The percentage columns in the right portion of the table indicate percentage changes of the respective columns relative to the Tgt 185 current commercial version of the plastic container (i.e., also referenced as percentage differences from UC).

As generally indicated, embodiments of plastic containers of the type disclosed herein may have materially reduced thickness at numerous container positions (e.g., as demonstrated at wall map points) and may further have a significantly reduced material weight, while yet meeting structural/functional requirements for such containers (for example passing a 45 pound top load strength test and/or a static four foot drop test). For example and without limitation, a wall thickness at an upper portion of a label panel (e.g., Wall Map Point 7) may have a thickness in a commercial embodiment (Tgt 185) of 0.046 inches. However, at relatively the same position on embodiments as disclosed herein (Rev. B) may have thicknesses of about 0.032, 0.031, or 0.014 inches (with container overall lightweighting of 20%, 27%, 50%, respectively).

For example and without limitation, a wall thickness at a generally more central portion of a label panel (e.g., Wall Map Point 11) may have a thickness in a commercial embodiment (Tgt 185) of 0.042 inches. However, at relatively the same position on embodiments as disclosed herein (Rev. B) may have thicknesses of about 0.030, 0.024, or 0.012 inches (with container overall lightweighting of 20%, 27%, 50%, respectively).

For further example and without limitation, a wall thickness at a portion in the base (e.g., Wall Map Point 42) may have a thickness in a commercial embodiment (Tgt 185) of 0.035 inches. However, at relatively the same position on embodiments as disclosed herein (Rev. B) may have thicknesses of about 0.024, 0.020, or 0.019 inches (with container overall lightweighting of 20%, 27%, 50%, respectively). Embodiments of Rev F versions of plastic containers, such as disclosed herein, can provide overall weight reduction of up to 20%, 20% to 30%, up to 35%, or even up to 50% such as compared to substantially similar overall size, shape and configured conventional UC plastic containers, while still potentially meeting structural/functional requirements for such containers. substantially similar overall size, shape, and configuration.

Plastic containers in accordance with aspects or teachings of the disclosure have a first opening, a second opening positioned about an opposite side of the container, a handle disposed between the first opening and the second opening, a base portion, a capacity of about 154 fluid ounces, and (i) a thickness in a label panel in a sidewall portion of about 0.030 inches or less, and/or (ii) a thickness in a central or pushup portion of the base of about 0.024 inches or less. Further, such a plastic container may pass a 45 pound top load strength test and/or a static four foot drop test.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. An extrusion blow molded plastic container, comprising:
a first opening;
a second opening disposed on an opposite side of the plastic container from the first opening;
a handle portion disposed between the first opening and the second opening;
a sidewall portion including a label panel; and
a base portion comprising an outer base portion including a support surface, and an inner base portion including a pushup portion;
wherein the plastic container has a capacity of at least 150 fluid ounces and, when unfilled and unlabeled, a weight of 172 grams or less;
wherein a wall thickness at a sidewall portion within a label panel area is 0.032 inches or less; and
wherein a wall thickness at a central portion of the pushup portion is 0.024 inches or less.

2. The extrusion blow molded plastic container of claim 1, wherein a maximum height of the plastic container at a top of the second opening is about 276.10 mm.

3. The extrusion blow molded plastic container of claim 1, wherein a maximum height of the pushup portion above a lowermost portion of the plastic container is about 0.79 mm.

4. The extrusion blow molded plastic container of claim 1, wherein the plastic container comprises at least one of high density polyethylene (HDPE), polypropylene (PP), and polyethylene terephthalate (PET).

5. The extrusion blow molded plastic container of claim 1, wherein the wall thickness at the sidewall portion within the label panel area is about 0.030 inches or less.

6. The extrusion blow molded plastic container of claim 1, wherein the wall thickness at the central portion of the pushup portion is about 0.020 inches or less.

7. The extrusion blow molded plastic container of claim 1, wherein a wall thickness of the plastic container at a heel portion or base transition zone between the sidewall portion and the base portion is about 0.023 inches or less.

8. The extrusion blow molded plastic container of claim 1, wherein a wall thickness at the outer base portion proximate to the support surface is greater than a wall thickness at the central portion of the pushup portion.

9. The extrusion blow molded plastic container of claim 8, wherein the wall thickness at the outer base portion proximate to the support surface is at least about 0.030 inches, and the wall thickness at the central portion of the pushup portion is about 0.024 inches or less.

10. The extrusion blow molded plastic container of claim 1, wherein the label panel comprises a first label panel on a first side of the plastic container and a second label panel on an opposite second side of the plastic container, and each of the first label panel and the second label panel is tapered and includes a heel chamfer.

11. The extrusion blow molded plastic container of claim 10, wherein each of the first label panel and the second label panel includes at least about 1 degree of additional taper relative to a corresponding label panel of a conventional plastic container of substantially similar overall size, shape, and configuration.

12. The extrusion blow molded plastic container of claim 1, wherein the plastic container is capable of passing a 45-pound top load strength test and a four-foot free-fall drop test.

13. The extrusion blow molded plastic container of claim 12, wherein the plastic container exhibits a torsional top load force resistance in a range of about 16 to about 25 pound-force.

14. The extrusion blow molded plastic container of claim 1, further comprising an overcap removably secured to the first opening, the overcap comprising a dosing cup including measurement markings formed as part of the overcap.

15. The extrusion blow molded plastic container of claim 1, wherein the plastic container is a multi-layer container comprising:
an inner polymer layer;
an outer polymer layer;
a middle polymer layer disposed between the inner polymer layer and the outer polymer layer; and
at least one adhesive layer disposed between adjacent polymer layers.

16. A multi-layer extrusion blow molded plastic container, comprising:
a sidewall portion;
a base portion comprising an outer base portion including a support surface, and an inner base portion including a pushup portion;
an inner polymer layer comprising virgin material with little or no added colorant;
an outer polymer layer;
a middle polymer layer disposed between the inner polymer layer and an outer polymer layer, the middle polymer layer comprising up to 50% post-consumer recycled (PCR) content; and
at least one adhesive layer disposed between adjacent polymer layers;
wherein the inner polymer layer, the middle polymer layer, and the outer polymer layer respectively comprise 10% or less, at least 50%, and 30% or less of a total weight of the plastic container when unlabeled and unfilled;
wherein a wall thickness at a sidewall portion within a label panel area is about 0.032 inches or less; and
wherein a wall thickness at a central portion of the pushup portion is about 0.024 inches or less.

17. The multi-layer extrusion blow molded plastic container of claim 16, comprising five layers including a first adhesive layer disposed between the outer polymer layer and the middle polymer layer and a second adhesive layer disposed between the middle polymer layer and the inner polymer layer.

18. The multi-layer extrusion blow molded plastic container of claim 16, wherein the middle polymer layer further comprises reground material.

19. A method of forming a lightweight extrusion blow molded plastic container with controlled material distribution, comprising:
extruding a multi-layer parison comprising at least an outer layer, a middle layer, and an inner layer, with at least one adhesive layer disposed between adjacent layers, wherein parison wall thickness is controlled such that a wall thickness of the formed container at a sidewall portion within a label panel area is 0.032 inches or less and a wall thickness at a central portion of a pushup portion of a base of the formed container is 0.024 inches or less;
inflating the parison within a blow mold using compressed air to form the plastic container such that the inner layer comprises virgin polymer material with little or no added colorant, the middle layer comprises up to 50% post-consumer recycled content, and the inner layer, middle layer, and outer layer respectively comprise 10% or less, at least 50%, and 30% or less of a total weight of the formed container when unlabeled and unfilled; and
cooling the formed container to solidify the layers;
wherein the formed container has a capacity of at least 150 fluid ounces and an unlabeled and unfilled weight of 172 grams or less.

20. The method of claim 19, wherein the blow mold is one of a plurality of blow molds mounted on a rotating wheel apparatus that continuously cycles through extrusion, molding, and ejection stages.
